(19) United States
(12) Patent Application Publication
(10) Pub. No.: US 2004/0155868 A1
(43) Pub. Date: Aug. 12, 2004

(54) Devices, apparatus and appliances with location reconfigurable input keys

(76) Inventor: Cheuk Fai Howard Hui, Hong Kong (CN)

Correspondence Address: BURNS DOANE SWECKER & MATHIS L L P, POST OFFICE BOX 1404, ALEXANDRIA, VA, 22313-1404, US

(21) Appl. No.: 10/704,598

(22) Filed: Nov. 12, 2003

(30) Foreign Application Priority Data
Feb. 10, 2003 (CN) 03100961.2

(51) Int. Cl. G09G 5/00

(52) U.S. Cl. 345/168

(57) ABSTRACT

An apparatus including a plurality of input keys for user interfacing

said input keys being relocatably mounted on said apparatus and can be relocated to other positions on said apparatus adapted for receiving said input keys,

said input keys include identification means which co-operate with detection means of said apparatus for ascertaining the individual identity of said input keys,

said input keys also include indicia for user identification and selection.

### FIELD OF THE INVENTION

The present invention relates to electronically controlled devices, appliances and apparatus with data input or user interfacing terminals. More specifically, although of course not solely limited thereto, this invention relates to electronic devices with key-location reconfigurable input terminals. This invention also relates to methods for reconfiguration of data input keys on data input terminals of electronic devices, appliances and apparatus and electronic devices, appliances and apparatus incorporating same.

### BACKGROUND OF THE INVENTION

Electronic devices, appliances and apparatus (collectively “electronic apparatus”) are frequently provided with data input or user interfacing keyboards or terminals. For example, computers are provided with keyboards for data entry as well as user interaction. Many industrial, scientific and medical apparatus nowadays are usually digitally or microprocessor controlled so that control or data input terminals are required to set apparatus or system parameters. With the ever decreasing costs of microprocessors and peripheral devices, domestic or household appliances nowadays are also widely equipped with microprocessors. As a result, input keyboards for controlling are also more commonly found on such appliances.

In general, data input or user interaction terminals (collectively for succinctness, the “keyboards”) are generally provided with a plurality of data input or command keys. The keys are generally provided with physical indicia, for example, symbols, alphabets, characters for user identification and selective actuations. Such indicia may be in the form of two-dimensional labels or three-dimensional contoured patterns. Typically, the data input or controlled keys are disposed or arranged in a fixed manner pre-determined by the manufacturers. An operator using the keyboards is therefore required to learn, memorize and be accustomed to the key arrangements in order to perform efficient data entry or interactive commands.

Furthermore, where alphanumerical keyboards are provided with such computers, appliances or apparatus, they are usually the “QWERTY” type as the basic version of the QWERTY keyboard has been around since the 19^{th} century. However, it is known that the QWERTY configuration is inefficient and new keyboard arrangements, for example, the Dvorak simplified keyboard, have been developed to reduce errors and increase typing speed. Thus, an operator familiar with the Dvorak keyboard may be found provided with the QWERTY and vice versa. For devices or apparatus with numerical inputs, for example, mobile phones, it is also known that the various arrangements of the 0-9 numerical keys can cause user inconvenience and confusion.

As computers and other electronic apparatus are usually factory provided with a specific data entry keyboard, this inevitably means a sacrifice in speed or accuracy for operators not particularly proficient with the keyboard provided. While software is available to convert or reconfigure the disposition of the alphanumerical keys or other keys on a keyboard from, for example, QWERTY to the Dvorak keyboard or other arrangements, the individual keys are generally labelled with specific numerals or alphabets which may affect the operator in the course of data entry or even confuse the unaware.

Hence, it will be desirable if there can be provided keyboards with reconfigurable keys which alleviate the shortcomings of conventional alphanumeric or other keyboards. Such keyboards should be easily reconfigurable without undue complexity or without the need of specialized tools so that individual operators can conveniently reconfigure the keyboards to maximize their performance.

### OBJECT OF THE INVENTION

Hence, it is an object of the present invention to provide reconfigurable keyboards and apparatus incorporating same which alleviate the shortcomings associated with conventional keyboards. At a minimum, it is an object of the present invention to provide the public with a choice of an alternative reconfigurable keyboard.

### SUMMARY OF THE INVENTION

According to the present invention, there is provided an apparatus including a plurality of input keys for user interfacing

said input keys being relocatably mounted on said apparatus and can be relocated to other positions on said apparatus adapted for receiving said input keys,

said input keys include identification means which co-operate with detection means of said apparatus for ascertaining the individual identity of said input keys,

said input keys also include indicia for user identification and selection.

Preferably, said apparatus includes a keyboard housing and said input keys being mounted on said keyboard housing, said keyboard housing includes a distributed detection network for identifying the input key being physically actuated.

Preferably, said input keys being detachable from and re-insertable onto said keyboard.

Preferably, said input keys being reconfigurable by sliding along predetermined tracks or channels on said keyboard housing.

Preferably, said input keys include electrical identification characteristics for electrical signal identification by said detection means.

Preferably, said input keys include electrical identification means and said distributed detection network includes corresponding electrical characteristic detection means.

Preferably, said distributed network includes a plurality of detection means corresponding to the number of said input keys, said detection means includes a detection matrix for ascertaining the identity of said input keys.

Preferably, said detection matrix includes a plurality of contact pads and said input keys include contact means disposed corresponding to a predetermined selection of contact pads on said input housing for identification.

Preferably, the contact pads on said detection matrix are disposed on a plurality of piled circuit boards wherein the contact pads on one circuit board surrounds that on the others.

Preferably, the identification on said input keys include optically recognizable patterns and said detection means include pattern recognition means.

According to a preferred embodiment of the present invention, there is therefore provided an apparatus including a plurality of relocatable input keys, wherein said input keys include physical indicia for user identification and selection, said input keys being provided with identification means and said apparatus include common detection means for ascertaining the identity of said input keys.

According to a further aspect of the present invention, there is provided a detachable key for use with a key location-reconfigurable keyboard including an outer key housing, a resilient means, an intermediate member and an identification means, said identification means being characteristic of the identity of said detachable key, said outer means includes means for detachably engaging with the housing of said key-reconfigurable, said intermediate member including means to co-operate with said housing of said location-reconfigurable keyboard and said housing of said detachable key so that said outer housing being resiliently movable towards said keyboard, said resilient means being disposed between said outer housing and said intermediate member so that relative movement between said outer housing of said detachable key and said intermediate member being under spring urge.

### BRIEF DESCRIPTION OF THE DRAWINGS

Preferred embodiments of the present invention will be explained in further detail below by way of example and with reference to the accompanying drawings in which:—

FIG. 1 is an example of an alpha-numerical keyboard of the present invention configured according to the conventional “QWERTY” arrangement,

FIG. 2A is a cross-sectional view along the section line A of the keyboard of FIG. 1,

FIG. 2B is the enlarged view of the encircled portion of FIG. 2A,

FIG. 3A shows the plan view of a keyboard of a second embodiment of the present invention,

FIG. 3B shows schematically the partial layout of the channels or tracks of the keyboard of FIG. 3A as well as the corresponding projections of some of the keys on the layer underneath the top housing of the keyboard,

FIG. 4A is a cross-sectional view showing the keyboard of FIG. 3A along the section line A-A,

FIGS. 4B and 4C show respectively the enlarged view of the enclosures marked “A1” and “B1” of FIG. 4A,

FIG. 4D is a cross-sectional view showing the cross section of some of the keys of the keyboard of FIG. 3A,

FIG. 4E is an enlarged view showing the enclosure marked “C1” of FIG. 4D,

FIGS. 4F, 4G, 4H and 41 show various component parts of the input key and the circuit board for use in the present invention,

FIG. 5A illustrates the circuit board layout of part of the detection means of the keyboard for the present invention,

FIG. 5B is an enlarged view of enclosure marked “D” of FIG. 5A,

FIG. 6A shows the circuit board layout of another part of the detection means of the present invention,

FIG. 6B shows in more detail the enlarged view of the enclosure marked “E” of FIG. 6A,

FIG. 7A shows the circuit board layout of another part of the detection means of the circuit board of the present invention,

FIG. 7B is an enlarged view of enclosure marked “F”,

FIG. 8A, FIG. 8B and FIG. 8C illustrate respectively the parts of an input key of a first example, the assembled form and the correspond projection on detection matrix,

FIG. 9A, FIG. 9B and FIG. 9C illustrate respectively the parts of an input key of a second example, the assembled form and the correspond projection on detection matrix,

FIG. 10 illustrates inter-relationship of various parts constituting the detection matrix,

FIG. 11 illustrates the inter-relationship between actuation key and the underlying detection means of the present invention, and

FIGS. 12A-12E show other possible combination of the identification counter points on actuation and the corresponding detection matrix projection.

FIG. 13A shows an exploded view of a first preferred embodiment of a removable key sub-assembly of the present invention,

FIG. 13B is a longitudinal view of the component parts of two adjacent keys and the correspondence receiving structure on a keyboard,

FIG. 13C shows a cross-sectional view of one of the removable keys sub-assembly of FIG. 13A when mounted onto a keyboard,

FIG. 13D is a perspective view showing a corresponding structure on a keyboard for receiving the key of FIG. 13A,

FIG. 13E is an exploded view of the component parts 313 and 314 of the sub-assembly,

FIG. 13F shows the assembled form of the components 313 and 314,

FIG. 13G is a partially exploded view of FIG. 13D,

FIG. 14A is an exploded view of a removable key of a second preferred embodiment of the present invention,

FIG. 14B is a cross-sectional view of two of the keys of FIG. 14A when mounted on a keyboard,

FIG. 14C is a cross-sectional view along a substantially orthogonal direction of FIG. 14B,

FIG. 14D is a perspective view showing the corresponding structure on a keyboard for receiving the key sub-assembly of FIG. 14A, and

FIG. 14E shows a longitudinal cross-sectional view of the components of the keys of FIG. 14A and part of the keyboard.

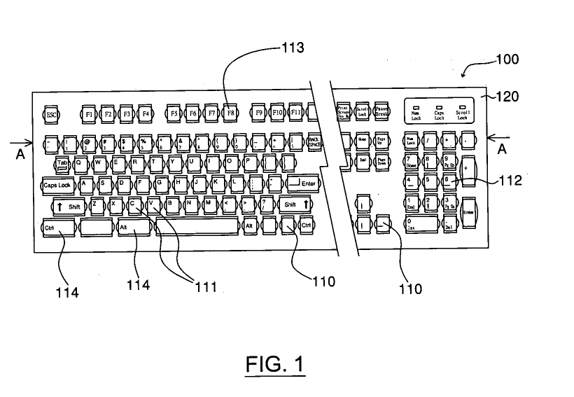

### DETAILED DESCRIPTION OF THE PREFERRED EMBODIMENTS

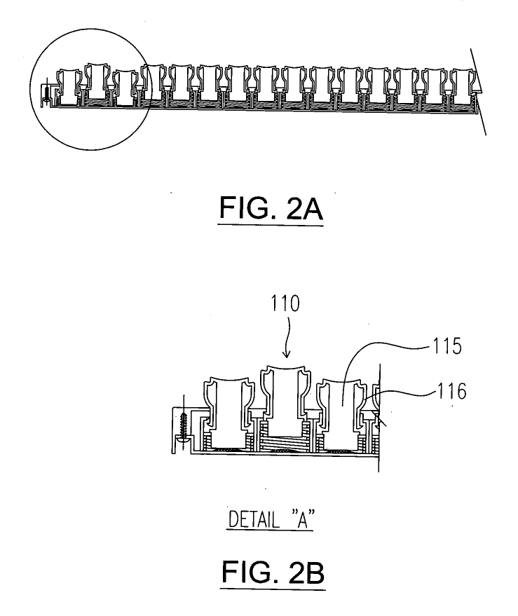

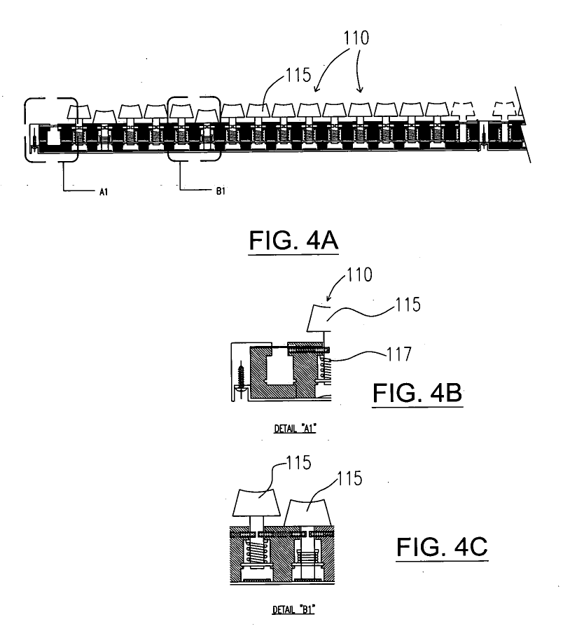

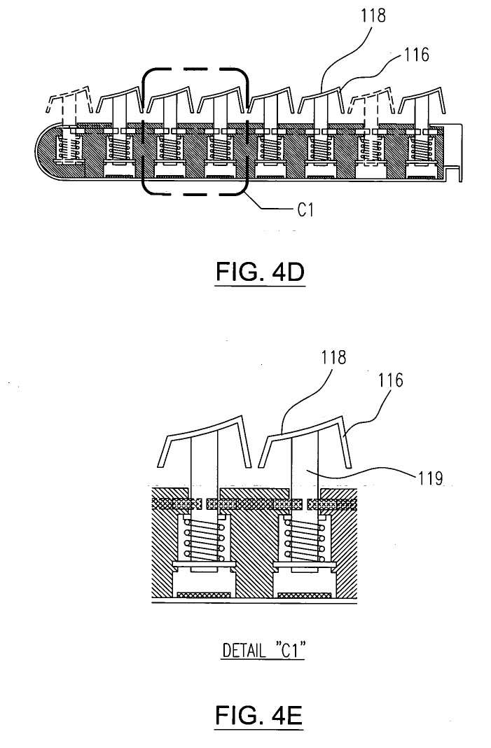

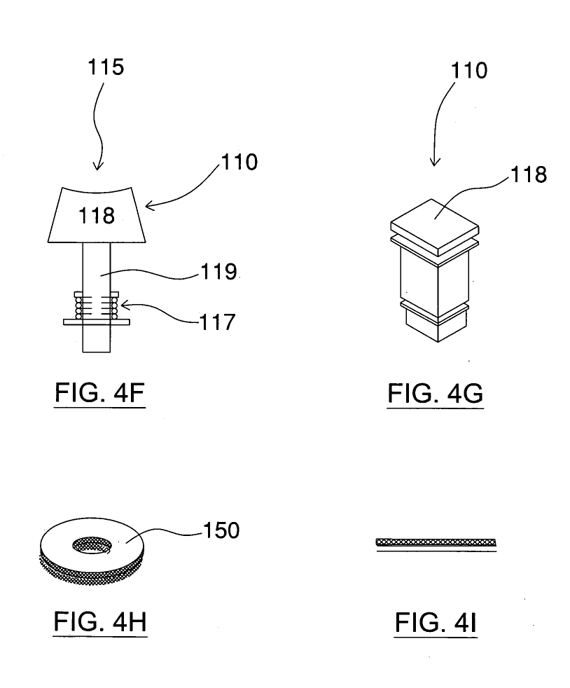

Referring firstly to a first preferred embodiment of a keyboard of the present invention, the keyboard 100 includes a plurality of input keys 110 which may be alphabetical keys 1;11, numerical keys 112, function keys 113, control keys 114 and other appropriate keys. The input keys 110 (including generally the alphanumeric keys, function keys and control keys) are mounted on a keyboard housing 120 which may be rigid, flexible, foldable or resilient. It will be noted from the description below that the locations of the input keys 100 are reconfigurable at various predetermined locations to be determined by a user. A more detailed cross-section of the key arrangements of the keyboard 110 are shown in FIGS. 2A and 2B as well as FIGS. 4A-4H.

Referring, for example, to FIGS. 2B to 4B, the input keys 110 include a body 115 with a pair of resilient arms 116 with inverted hooks. The keys 110 are mounted on the housing of the keyboard against spring bias 117 and the pair of resilient arms are provided to guide the movement of the keys along a direction to actuate and de-actuate the keys 110.

As shown in FIGS. 4B to 4F, the input key 110 includes a cap portion 118 and the stem portion 119. An operator activates the input key 110 by pressing downwards on the top of the cap 118 which then moves the stem portion 119 downward to make contact with or trigger the associated detection means on the keyboard or apparatus. A hard plastic key housing 120 may be provided to receive the key body 115. A collar means may be formed on the housing to surround the stem to allow guided relative translation movements of the key body 115 along the actuation direction. A washer 150, for example, a soft plastic washer, is inserted into the stem portion 119 to shield the detection circuitry on the keyboard housing 120 to prevent dust or other contaminants from entering the electrical contact areas and to hold the keys in place. Each of the input keys 110 are generally provided with physical indicia to enable an operator to identify and select the appropriate keys. Such physical indicia may, for example, include two dimensional or three-dimensional labels corresponding to the symbols representing the alphabets, numerals and control or function options.

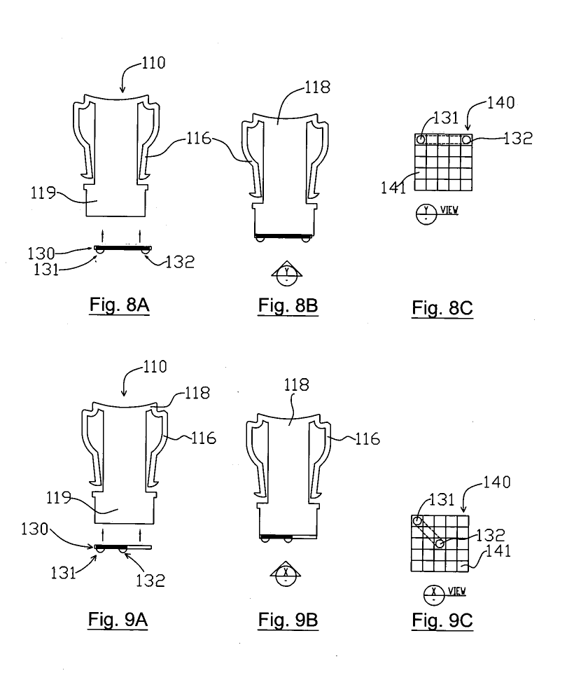

To enable flexible reconfigurability, each input key 110 is provided with a characteristic identification means which, when incorporated or coupled with the corresponding detection means provided on the keyboard or apparatus, will provide sufficient identification information enabling the decision circuitry, for example, the embedded microprocessor, to be informed of the specific key being actuated. In the present preferred embodiments and as shown more particularly in FIGS. 8A to 9C, each input key 110 includes an identification board 130 which includes a pair of contact pads 131, 132 on the underside which is the side opposite the detection board 200 on the keyboard housing 120. The contact pads 131, 132 include, for example, contact conductive bumps for more effective and reliable contact and are disposed so that their projections coincide with a specific grid combination on the corresponding detection means on the keyboard detection circuitry as shown in FIGS. 8C and 9C.

The detection means as shown in the present embodiments include a matrix of orderly arranged conductive grid array 140. For example, the physical locations of the conductive bumps formed on the underside of the identification board 130 of FIG. 8A correspond to row 1 column 1 and row 1 column 5 of the detection grid array 140 of FIG. 8C. Similarly, the projection of the identification conductive bumps 131, 132 on the input keys of FIG. 9A corresponds to locations row 1 column 1 and row 3 column 3 of the detective grid array, as shown in FIG. 9C.

By providing the resilient arms 116 as shown in FIG. 2B, the input keys 110 can be detachably removed from one location on the keyboard to another without tools. As the physical indicia and the identification means are attached with the individual input keys, the relocated keys will bring with their relocation the associated identification characteristics. Thus, for example, the alphabet key “A” in the conventional QWERTY keyboard can be relocated to position, say, for example, Y, of the new keyboard as reconfigured according to the wish of the operator.

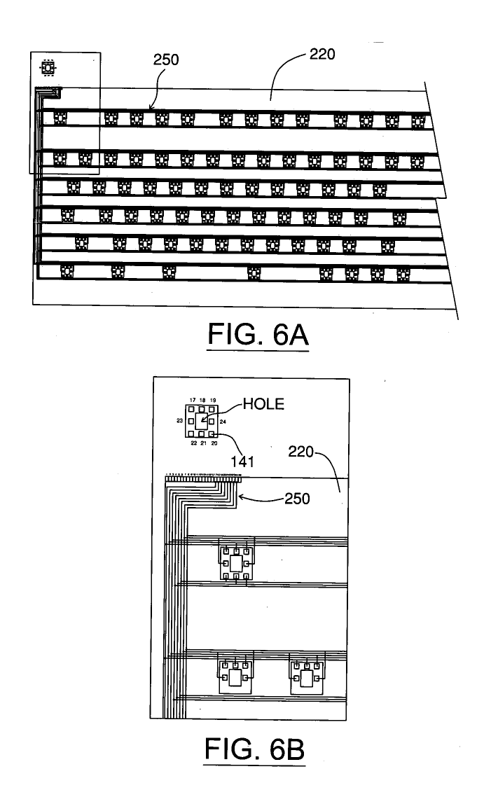

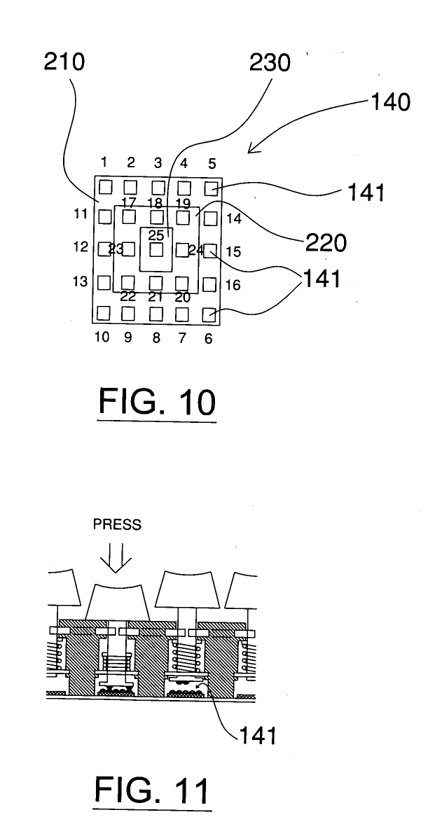

Referring to FIG. 11 showing in more detail the detection grid array 140 as described in FIGS. 8C and 9C, it will be noted that the detection grid array 140 includes a plurality of conductive pads 141 arranged in an orderly manner. More specifically, the present detection grid array 140 example includes a total of 25 conductive pads arranged in a square grid array comprising 16 conductive pads arranged on the outer square, 8 conductive pads arranged on the intermediate square and a single conductive pad in the innermost squares. In order to provide the maximum contact area for each conductive pad 140 on the detection means and to provide a simplified signal routing for ascertaining a particular combination of conductive pads for specific key identification, the detection means in the present embodiments comprises three overlapping layers 210, 220 and 230. In the lower most layer 210, a grid array with 16 conductive pads arranged along the outside edges is laid out. In the second circuit board 220, a total of 8 conductive pads are distributed on the outer edges of a square corresponding to the intermediate square as shown in FIGS. 6B and 10 are provided. At last, a third circuit board 230 with a single conductive pad for identification must be provided. The three circuit boards are plied together so that the collective conductive pads are disposed together to form an orderly square grid or matrix manner 140 as shown in FIG. 10.

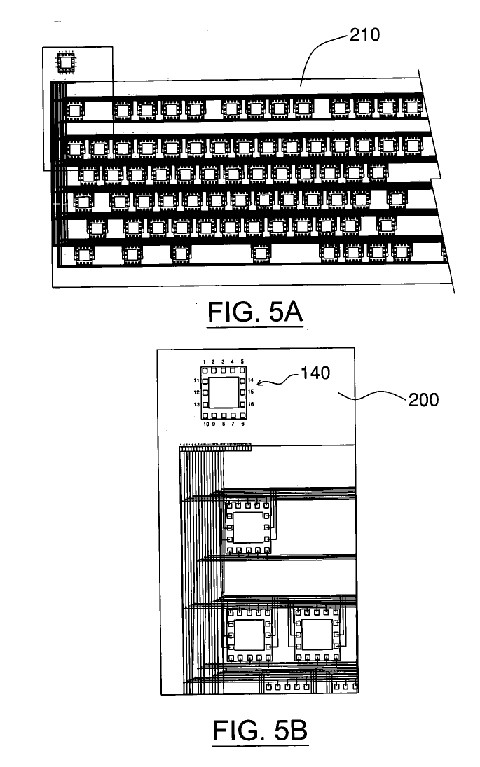

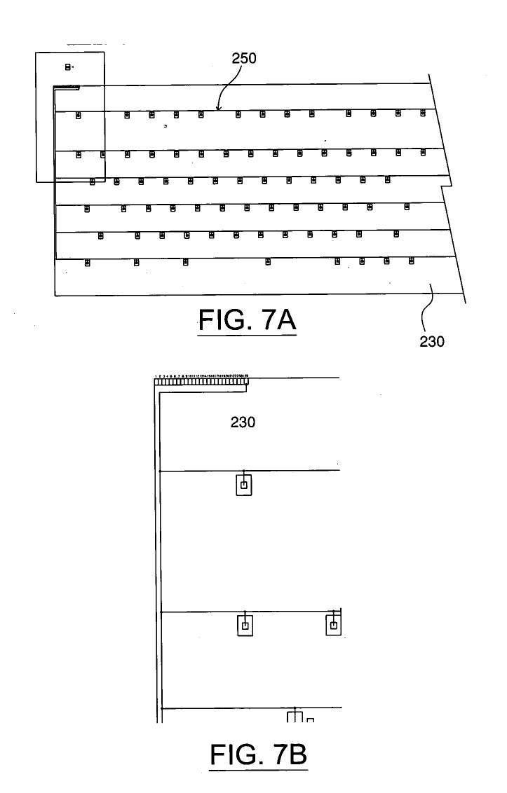

An example circuit board layout of the first circuit board layer 210 is shown in FIGS. 5A and 5B. The corresponding second circuit layer layout 220 is shown in FIGS. 6A and 6B and the third layer 230 comprising a single conductive pad is shown in FIGS. 7A and 7B. While the formation of the detection means by the use of the overlying circuit boards will simplify signal routing, it will be understood that the detection means or the detection circuitry can be formed on a single or a multi-layered circuit board with appropriate signal routing. Also, the circuit boards for the detection circuitry or means can be rigid or flexible circuit boards while flexible boards are preferred as their use can reduce the overall thickness of the detection circuitry.

In assembling the detection circuitry, the three detection circuit boards with common guiding means, for example, guiding apertures or other appropriate means are assembled together and the output signals, through the signal tracks 250, from each of the circuit boards are combined together for determining the identity of the input G being actuated.

In the present example, as there are 25 detection conductive pads, a total of ²⁵C₂ combinations are available for individual key identifications. On the other hand, where a smaller number of key combinations are required, for example, when ¹⁶C₂ or ⁸C₂, are required, a single circuit board may be sufficient to provide the necessary combinations. Of course, the actual number of boards and the number of conductive boards distributed on each identification circuitry will also depend on the minimum acceptable spacing between adjacent conductive pads and the maximum foot-print acceptable for each key detection circuitry. When the input key of FIG. 2B is to be removed from the keyboard, the pair of resilient arms are to be pressed towards each other to provide sufficient clearance for the removal passage of the key body. As the locking arms are resilient with a pair of inverted hooks at their lowest extremes, the keys can be reinserted and engaged on the keyboard at the appropriate key location and locked in place.

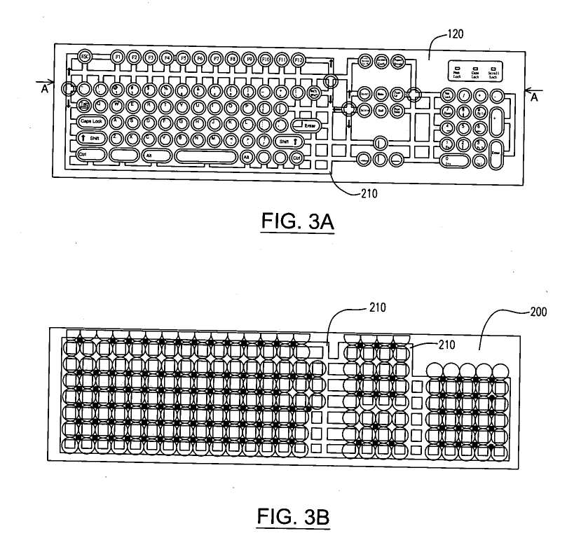

Referring now to FIGS. 3A and 3B showing a second preferred embodiment of the present invention, the keyboard 200 housing is provided with a plurality of interconnected tracks 210 so that the keys are slidably movable along the channels or tracks. By moving the input keys, for example, in a manner as shown in FIG. 3A, the keys can be relocated. As the input keys are provided with identification means similar to the keys of the first embodiment, and a similar detection circuit board is provided underneath the input keys, the input keys can be identified by the underlying detection circuitry irrespective of the instantaneous location of the keys. Of course, the tracks are provided with location indication means confirming that the input keys are in proper alignment with the underlying detection circuitry to ensure proper identification. Thus, with the use of a keyboard housing having a plurality of interconnecting key channels or tracks, the keys can be reconfigured by sliding along those tracks and channels while minimizing the risk of key loss.

It will be noted that while electrical identification means by way of a pair of conductive bumps are formed on the lower side of each individual input keys, it will be understood that other identification means, for example, optical or pattern recognition means can be used so that a specific pattern can be formed on the underside of the input key and a corresponding pattern recognition means can be used to ascertain the specific identity of the keys being actuated.

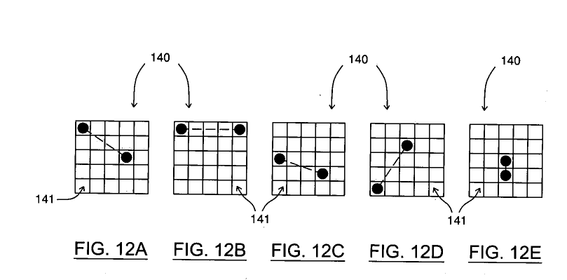

FIGS. 12A-E shows a plurality of combinations of the conductive bumps indicating the possible variation of the foot-prints of the conductive bumps on the input key corresponding to the detection grid arrays. Of course, the conductive grids may be connected with a conductive track or specific resistors so that the identity of the keys can be identified by the range of resistance measured between the two conductive bumps. As a further example, the identity of the input keys can be identified by other electrical characteristics such as, for example, resistance or impedance between contact terminal for identification purpose without loss of generality.

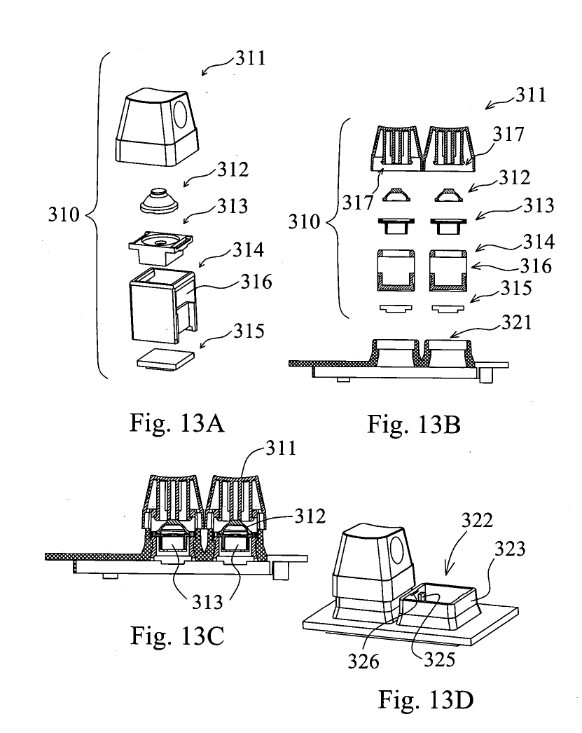

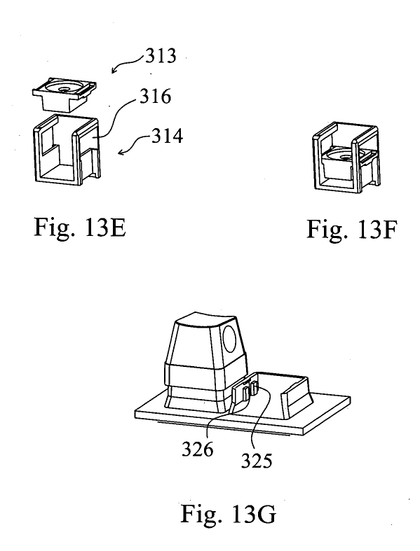

FIGS. 13A to 13G show in more detail a first preferred embodiment of a removable key sub-assembly of the present invention. The key 310 includes an upper housing (or an outer cap) 311, a resilient member 312, an intermediate member 313, an inner housing 314 and an identification means 315. The identification means 315 includes a contact member which is equivalent to the identification board 130 described above and includes a pair of identification contact pads 131, 132 on the underside for making contact with the circuitry on the main keyboard housing. The contact member of the identification means is attached to the bottom of the inner housing 314 so that the contact pads on the contact member will make electrical contacts with the electronic circuitry on the keyboard housing when the inner housing 314 is adequately depressed.

The intermediate member 313 has a wing-shaped extension at its lateral sides so that the intermediate member 313 has generally a T-shaped cross-section. To assemble the removal key 310, the deformable T-shaped intermediate member 313 is inserted into the inner housing 314 through the side aperture 316 of the inner housing 314.

The lateral dimension of the T-shaped intermediate member 313 being designed so that when the key sub-assembly 310 is inserted onto the key receptacle 322 of the keyboard housing 321, the protruding portions of the T-shaped intermediate member 313 will be trapped by a catching mechanism (325, 326) formed on the inner surface of the key receptacle 324, thereby generally preventing the intermediate member 313 to move relative to the catching member.

After the intermediate member 313 has been inserted into the inner housing 314, the resilient member 312 is placed onto top surface of the intermediate member 313 and in the confined space between the outer cap 311 and the intermediate member 313. The outer cap 311 is then mounted onto the inner housing 314. A pair of latching mechanism 317 formed on the inside of the outer cap 311 and the inner housing 314 will cause the two housings to attach, for example, by snap-fit, thereby forming a sub-assembly of a removable key comprising the parts 311-315.

When the removable key sub-assembly 310 has been formed, the resilient member 312, which can for example include a bell-shaped silicone or rubber member or a spring, is being trapped between the intermediate member 313 and the outer housing or the outer cap 311. Furthermore, the intermediate member is movable along the axial direction of and relative to the inner housing between the top and bottom ends of the side apertures 316.

On the keyboard housing 321, there are formed a plurality of removable key receptacles 322. Two key receptacles have been shown in the Figure as a convenient example. The key receptacle 322 includes a peripheral wall 323 which is shaped and dimensioned to correspond to that of the inside of the lower part of the outer housing 311. The key receptacle 322 includes a catching mechanism comprising protrusions 325 and 326 on opposite sides of the key receiving aperture 324. The catching mechanism comprises the protrusion 325 and 326 which are dimensioned so that when the removal key sub-assembly 310 is inserted into the aperture 324 of the key receptacle 322, the protruding edges of the intermediate member 313 will be caught and trapped by the catching mechanism so that the intermediate member will be prevented from moving along the axial direction of the aperture 324.

When the outer cap 311 is depressed, parts 311, 314 and 315 will move downwards relative to the key receptacle 322 until the identification means makes contact with the circuit board on the keyboard housing. As the intermediate member 313 is restrained from moving along the axial direction of the aperture 322, the space between the top of the intermediate member 313 and the outer cap is reduced, thereby axially compressing the resilient member 312. When the downward depressing force has been removed from the outer cap 311, the stored resilient energy in the resilient member will be released, thereby pushing the outer cap 311 and the connected parts 314 and 315, away from the circuitry on the keyboard housing, thereby terminating the contact.

It will be appreciated that the catching mechanism 325 and 326 and the engaging portions on the T-shaped intermediate member are made for easy insertion and removal while at the same time provides sufficient resistance to prevent inadvertent release of the removable key sub-assembly 310 when the stored compression energy is released from the resilient member 312.

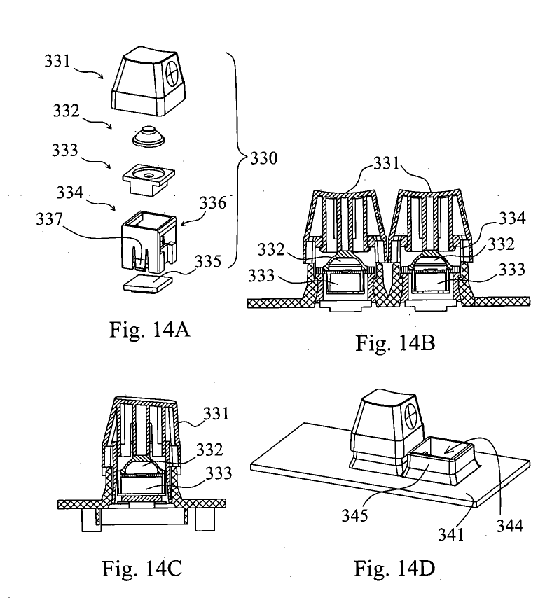

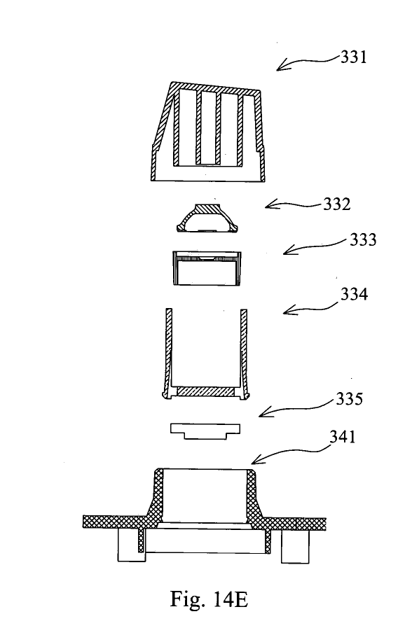

FIGS. 14A to E show in more detail a second preferred embodiment of a removable key sub-assembly 330 of the present invention. Similar to the structure of the first preferred embodiment of a removal key sub-assembly 310 described above, a removable key sub-assembly 330 includes an outer housing 331, a resilient member 332, an intermediate member 333, an inner housing 334 and contact identification means 335. The components in this sub-assembly 330 are generally identical to that of the first preferred embodiment 310 with the primary exception of the inner housing 334.

Instead of the intermediate member 333 being engaged with a latching mechanism formed on the receptacle, the inner housing 334 includes engagement means 337 for latching with corresponding engaging means on the key receptacle 344. Hence, the structure of this removal key sub-assembly 330 is generally identical to the first preferred embodiment 310 except that a movement limitation means 337 is formed on the inner housing 336. The movement limitation means 337 and the inner housing 336 in the present embodiment includes protruding teeth formed on opposite sides of the inner housing 336 which are to be trapped or caught by restraining means or latching mechanism formed in the key receptacle 344 which limits the upward axial freedom of movement of the inner housing 336.

The intermediate member 333 has a generally T-shaped cross-section with protruding parts the dimension of which exceeds that of the peripheral wall of the key receptacle 344. Thus, the peripheral wall of the key receptacle 344 will restrict the range of downward movement of the intermediate member 333. Thus, when the key sub-assembly 330 is inserted into the key receptacle 344, the catching means on the key receptacle 334 will restrict the upward movement of the inner housing 336 while the upper edges of the peripheral wall of the key receptacle 344 will prevent excess downward axial movement of the intermediate member 333.

When the outer cap 331 is being depressed, the entire sub-assembly 330 will move downwards until the intermediate member 333 is being restrained by the peripheral wall 345 at which point the outer cap 331, the inner housing 334 and the contact identification means 335 will move further downwards with the intermediate member 333 will begin to be detached from the other parts of the sub-assembly.

When the depression force acting on the outer cap 331 has been removed, the compressive energy stored in the resilient member 332 will be released, thereby moving the sub-assembly upwards. After the sub-assembly has moved axially upwardly for a predetermined range, the limiting means on the receptacle may prevent further upward movement of the inner housing and the stored energy in the resilient member will continue to move the outer cap 331 further upwards until all the stored energy has been released.

While the present invention has been explained by reference to the preferred embodiments described above, it will be appreciated that the embodiments are only illustrated as examples to assist understanding of the present invention and are not meant to be restrictive on its scope. In particular, the scope, ambit and spirit of this invention are meant to include the general principles of this invention as inferred or exemplified by the embodiments described above. More particularly, variations or modifications which are obvious or trivial to persons skilled in the art, as well as improvements made on the basis of the present invention, should be considered as falling within the scope and boundary of the present invention.

Furthermore, while the present invention has been explained by reference to a keyboard, it should be appreciated that the invention can apply, whether with or without modifications, to other device or apparatus without loss of generality.

1. An apparatus including a plurality of input keys for user interfacing
said input keys being relocatably mounted on said apparatus and can be relocated to other positions on said apparatus adapted for receiving said input keys,
said input keys include identification means which co-operate with detection means of said apparatus for ascertaining the individual identity of said input keys,
said input keys also include indicia for user identification and selection.

2. An apparatus according to claim 1, wherein said apparatus includes a keyboard housing and said input keys being mounted on said keyboard housing, said keyboard housing includes a distributed detection network for identifying the input key being physically actuated.

3. An apparatus according to claim 2, wherein said input keys being detachable from and re-insertable into said keyboard.

4. An apparatus according to claim 3, wherein said input keys being reconfigurable by sliding along pre-determined tracks or channels on said keyboard housing.

5. An apparatus according to claim 2, wherein said input keys include electrical identification characteristics for electrical signal identification by said detection means.

6. An apparatus according to claim 2, wherein said input keys include electrical identification means and said distributed detection network includes corresponding electrical characteristic detection means.

7. An apparatus according to claim 2, wherein said distributed network includes a plurality of detection means corresponding to the number of said input keys, said detection means includes a detection matrix for ascertaining the identity of said input keys.

8. An apparatus according to claim 7, wherein said detection matrix includes a plurality of contact pads and said input keys include contact means disposed corresponding to a pre-determined selection of contact pads on said input housing for identification.

9. An apparatus according to claim 8, wherein the contact pads on said detection matrix are disposed on a plurality of piled circuit boards wherein the contact pads on one circuit board surrounds that on the others.

10. An apparatus according to claim 2, wherein the identification on said input keys includes optically recognizable patterns and said detection means include pattern recognition means.

11. An apparatus including a plurality of relocatable input keys, wherein said input keys include physical indicia for user identification and selection, said input keys being provided with identification means and said apparatus include common detection means for ascertaining the identity of said input keys.

12. A detachable key for use with a key location-reconfigurable keyboard including an outer key housing, a resilient means, an intermediate member and an identification means, said identification means being characteristic of the identity of said detachable key, said outer means includes means for detachably engaging with the housing of said key-reconfigurable, said intermediate member including means to co-operate with said housing of said location-reconfigurable keyboard and said housing of said detachable key so that said outer housing being resiliently movable towards said keyboard, said resilient means being disposed between said outer housing and said intermediate member so that relative movement between said outer housing of said detachable key and said intermediate member being under spring urge.
